(19) United States
(12) Patent Application Publication
(10) Pub. No.: US 2026/0104678 A1
(43) Pub. Date: Apr. 16, 2026

(54) SYSTEMS AND METHODS FOR ROBOTIC PROCESS AUTOMATION AND MACHINE LEARNING FOR DYNAMIC NETWORK MONITORING AND PACKET VALIDATION IN ELECTRONIC ENVIRONMENTS

(71) Applicant: BANK OF AMERICA CORPORATION, Charlotte, NC (US)

(72) Inventors: Pratap Dande, Saint Johns, FL (US); Tony Aidoo, Aubrey, TX (US); Noell Y. Eury, Stanfield, NC (US); Brian Jacobson, Granada Hills, CA (US); Dennis Vranjesevic, Kent Cliffs, NY (US); Rahul Yaksh, Austin, TX (US); Bojan Zdravkovic, Jersey City, NJ (US)

(73) Assignee: BANK OF AMERICA CORPORATION, Charlotte, NC (US)

(21) Appl. No.: 18/917,299

(22) Filed: Oct. 16, 2024

(51) Int. Cl. G05B 13/02

(52) U.S. Cl. CPC G05B 13/0265

(57) ABSTRACT

Systems, computer program products, and methods are described herein for robotic process automation (RPA) and machine learning (ML) for dynamic network monitoring and packet validation in electronic environments. The present disclosure is configured to extract data from network data packets received from at least one or more data sources and determine, using an ML engine, at least one network event trigger based on the data. The system also determines, using the ML engine, bot criteria of an RPA bot based on the at least one network event trigger. Also, the system assigns the RPA bot to execute a network transmission protocol based on at least the bot criteria and executes, via the RPA bot, a network transmission protocol.

### TECHNOLOGICAL FIELD

Example embodiments of the present disclosure relate to robotic process automation and machine learning for dynamic network monitoring and packet validation in electronic environments.

### BACKGROUND

Network monitoring and packet validation in electronic environments pose significant technical and operational challenges. Executing network packet monitoring and network resource transfers requires secure networks, efficient data transmission execution, and compliant network protocols. Rule authorities issue binding rules governing network resource transfers, network monitoring, and remediation of identified threats. Failure to detect threats within the network may result in compromised security, regulatory deficiencies, and misappropriated network resources. Allocation of required computing resources to execute network transmission protocols, monitor network packets, and validate network data poses technical issues, as allocating too few computing resources may negatively impact network transmission protocol efficiency, degrade network packet monitoring, and increase the threat of network threats. Changing network conditions, network transmissions spanning multiple electronic environments, and network latency pose additional technical challenges for dynamic and effective network packet monitoring and validation.

With the increase in electronic environment network transmission protocols, it is essential to develop efficient technical solutions for dynamic network monitoring and packet validation in electronic environments. Conventional solutions often rely on inefficient, manually driven processes for executing network transmission protocols, validating network transfers, and ensuring compliance with regulatory requirements.

Applicant has identified a number of deficiencies and problems associated with robotic process automation and machine learning for dynamic network monitoring and packet validation in electronic environments. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for robotic process automation and machine learning for dynamic network monitoring and packet validation in electronic environments.

In one aspect, a system for robotic process automation and machine learning for dynamic network monitoring and packet validation in electronic environments. In some embodiments, the system may comprise: a memory device with computer-readable program code stored thereon; at least one processing device, wherein executing the computer-readable program code is configured to cause the at least one processing device to execute the computer-readable program code to: extract data from network data packets received from at least one or more data sources; determine, using a machine learning (ML) engine, at least one network event trigger based on the data; determine, using the ML engine, bot criteria of a robotic process automation (RPA) bot based on the at least one network event trigger; assign the RPA bot to execute a network transmission protocol based on at least the bot criteria; and execute, via the RPA bot, a network transmission protocol.

In some embodiments, executing the computer-readable program code is further configured to cause the at least one processing device to: determine, using the ML engine, whether the data comprises network rule criteria; reassign the RPA bot to execute a network threat protocol based on at least the network rule criteria; execute, using the RPA bot, the network threat protocol, wherein the network threat protocol comprises aggregating network packet threat data; generate a network threat map based on at least the network rule criteria and the network packet threat data; and transmit, using the RPA bot, a threat notification, wherein the threat notification comprises the network threat map.

In some embodiments, executing the computer-readable program code is further configured to cause the at least one processing device to: generate an event trigger forecast ML engine; update the event trigger forecast ML engine with the data; generate, using the event trigger forecast ML engine, an event trigger forecasting map; generate, using the RPA bot, a forecast network transmission protocol based on at least the event trigger forecasting map; and execute, using the RPA bot, the forecast network transmission protocol.

In some embodiments, executing the computer-readable program code is further configured to cause the at least one processing device to: determine, using the ML engine, that the at least one network event trigger comprises a network resource transfer request; assign a second RPA bot to execute a network resource transfer request authentication; execute, using the second RPA bot, the network resource transfer request authentication, wherein the network resource transfer request authentication comprises at least two of a one-time password, a physical attribute authentication, authentication application, and authentication credentials; assign the second RPA bot to execute a second network transmission protocol; and execute, using the second RPA bot, the second network transmission protocol, wherein the network transmission protocol comprises a network resource transfer.

In some embodiments, executing the computer-readable program code is further configured to cause the at least one processing device to: generate, using the ML engine, a query based on at least the network event trigger; query at least one internal database based on the query and retrieve query results; access and retrieve node data from at least one node in a distributed ledger based on at least the query results and the network event trigger; determine, using the ML engine, a network transmission threshold associated with the node data and the query results; and validate, using the ML engine, that the network transmission threshold exceeds a network rule threshold.

In some embodiments, executing the computer-readable program code is further configured to cause the at least one processing device to: receive at least one historical dataset; train the ML engine based on the at least one historical dataset, wherein the at least one historical dataset comprises at least one of historical network resource transfer data associated with historical network resource transfer criteria, historical validation data associated with validation criteria, historical network rule data associated with historical network rule criteria, or historical network transmission protocols; receive the network packet threat data; update the at least one historical dataset with the network packet threat data; and retrain the ML engine based on the network packet threat data.

In some embodiments, executing the computer-readable program code is further configured to cause the at least one processing device to: receive a request to generate a new account; receive, using the RPA bot, account data associated with a user; parse, using the RPA bot, the account data associated with a user to identify rules data; execute, using the RPA bot, a rules data verification protocol, wherein the rules data verification protocol comprises validating identification criteria and identifying vulnerabilities associated with the account data associated with the user; determine, using the RPA bot, an interception threshold based on the rules data verification protocol; and execute, using the RPA bot, an account generation protocol and an identification registration protocol, wherein the identification registration protocol comprises transmitting network data packets comprising the account data associated with the user to an external distributed ledger.

In some embodiments, executing the computer-readable program code is further configured to cause the at least one processing device to: generate a user interface on a display, wherein the user interface comprises at least one interactive dashboard; and generate at least one alert based on the network transmission protocol.

In some embodiments, executing the computer-readable program code is further configured to cause the at least one processing device to: receive control signals from a user device, wherein the control signals comprise a revised mode of the ML engine and revised configurations of the RPA bot; and update the ML engine and the RPA bot based on the control signals.

In some embodiments, executing the computer-readable program code is further configured to cause the at least one processing device to: determine, using the ML engine, that the at least one network event trigger comprises a distributed network resource transfer; receive, using the RPA bots, distributed network resources from a distributed network resource transfer source; and transmit, via the RPA bot, the distributed network resources to a network resource transfer account.

In another aspect, a computer program product for robotic process automation and machine learning for dynamic network monitoring and packet validation in electronic environments is provided. In some embodiments, the computer program product comprises at least one non-transitory computer-readable medium having computer-readable program code portion embodied therein, the computer-readable program code portions which when executed by a processing device are configured to cause a processor to: extract data from network data packets received from at least one or more data sources; determine, using a machine learning (ML) engine, at least one network event trigger based on the data; determine, using the ML engine, bot criteria of a robotic process automation (RPA) bot based on the at least one network event trigger; assign the RPA bot to execute a network transmission protocol based on at least the bot criteria; and execute, via a robotic process automation (RPA) bot, a network transmission protocol.

In some embodiments, the processing device is further configured to: determine, using the ML engine, whether the data comprises network rule criteria; reassign the RPA bot to execute a network threat protocol based on at least the network rule criteria; execute, using the RPA bot, the network threat protocol, wherein the network threat protocol comprises aggregating network packet threat data; generate a network threat map based on at least the network rule criteria and the network packet threat data; and transmit, using the RPA bot, a threat notification, wherein the threat notification comprises the network threat map.

In some embodiments, the processing device is further configured to: determine, using the ML engine, that the at least one network event trigger comprises a network resource transfer request; assign a second RPA bot to execute a network resource transfer request authentication; execute, using the second RPA bot, the network resource transfer request authentication, wherein the network resource transfer request authentication comprises at least two of a one-time password, a physical attribute authentication, authentication application, and authentication credentials; assign the second RPA bot to execute a second network transmission protocol; and execute, using the second RPA bot, the second network transmission protocol, wherein the network transmission protocol comprises a network resource transfer.

In some embodiments, the processing device is further configured to: generate, using the ML engine, a query based on at least the network event trigger; query at least one internal database based on the query and retrieve query results; access and retrieve node data from at least one node in a distributed ledger based on at least the query results and the network event trigger; determine, using the ML engine, a network transmission threshold associated with the node data and the query results; and validate, using the ML engine, that the network transmission threshold exceeds a network rule threshold.

In some embodiments, the processing device is further configured to: determine, using the ML engine, that the at least one network event trigger comprises a distributed network resource transfer; receive, using the RPA bots, distributed network resources from a distributed network resource transfer source; and transmit, via the RPA bot, the distributed network resources to a network resource transfer account.

In another aspect, a computer-implemented method for robotic process automation and machine learning for dynamic network monitoring and packet validation in electronic environments is provided. In some embodiments, the computer-implemented method comprising: extracting data from network data packets received from at least one or more data sources; determining, using a machine learning (ML) engine, at least one network event trigger based on the data; determine, using the ML engine, bot criteria of a robotic process automation (RPA) bot based on the at least one network event trigger; assign the RPA bot to execute a network transmission protocol based on at least the bot criteria; and executing, via a robotic process automation (RPA) bot, a network transmission protocol.

In some embodiments, the computer-implemented method is further configured for: determining, using the ML engine, whether the data comprises network rule criteria; reassigning the RPA bot to execute a network threat protocol based on at least the network rule criteria; executing, using the RPA bot, the network threat protocol, wherein the network threat protocol comprises aggregating network packet threat data; generating a network threat map based on at least the network rule criteria and the network packet threat data; and transmitting, using the RPA bot, a threat notification, wherein the threat notification comprises the network threat map.

In some embodiments, the computer-implemented method is further configured for: determining, using the ML engine, that the at least one network event trigger comprises a network resource transfer request; assigning a second RPA bot to execute a network resource transfer request authentication; executing, using the second RPA bot, the network resource transfer request authentication, wherein the network resource transfer request authentication comprises at least two of a one-time password, a physical attribute authentication, authentication application, and authentication credentials; assigning the second RPA bot to execute a second network transmission protocol; and executing, using the second RPA bot, the second network transmission protocol, wherein the network transmission protocol comprises a network resource transfer.

In some embodiments, the computer-implemented method is further configured for: generating, using the ML engine, a query based on at least the network event trigger; querying at least one internal database based on the query and retrieve query results; accessing and retrieving node data from at least one node in a distributed ledger based on at least the query results and the network event trigger; determining, using the ML engine, a network transmission threshold associated with the node data and the query results; and validating, using the ML engine, that the network transmission threshold exceeds a network rule threshold.

the computer-implemented method is further configured for: determining, using the ML engine, that the at least one network event trigger comprises a distributed network resource transfer; receiving, using the RPA bots, distributed network resources from a distributed network resource transfer source; and transmitting, via the RPA bot, the distributed network resources to a network resource transfer account.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for robotic process automation and machine learning for dynamic network monitoring and packet validation in electronic environments, in accordance with an embodiment of the disclosure;

FIG. 2 illustrates an exemplary machine learning (ML) subsystem architecture 200, in accordance with an embodiment of the disclosure;

FIG. 3 illustrates a process flow 300 for robotic process automation and machine learning for dynamic network monitoring and packet validation in electronic environments, in accordance with an embodiment of the disclosure;

FIG. 4 illustrates a process flow 400 for transmitting, using the RPA bot, a threat notification, wherein the threat notification comprises a network threat map, in accordance with an embodiment of the disclosure;

FIG. 5 illustrates a process flow 500 for executing, using the RPA bot, a forecast network transmission protocol, in accordance with an embodiment of the disclosure;

FIG. 6 illustrates a process flow 600 for executing, using a second RPA bot, a network resource transfer request authentication and a second network transmission protocol, in accordance with an embodiment of the disclosure;

FIG. 7 illustrates a process flow 700 for validating, using the ML engine, that a network transmission threshold exceeds a network rule threshold, in accordance with an embodiment of the disclosure;

FIG. 8 illustrates a process flow 800 for training and retraining the ML engine based on at least one historical dataset and network packet threat data, in accordance with an embodiment of the disclosure;

FIG. 9 illustrates a process flow 900 for executing, using the RPA bot, a rules data verification protocol, an account generation protocol, and an identification registration protocol, in accordance with an embodiment of the disclosure;

FIG. 10 illustrates a process flow 1000 for generating a user interface and generating least one alert based on the network transmission protocol, in accordance with an embodiment of the disclosure;

FIG. 11 illustrates a process flow 1100 for modifying the ML engine and the RPA bot, in accordance with an embodiment of the disclosure; and

FIG. 12 illustrates a process flow 1200 for transmitting, via the RPA bot, a distributed network resources transmission, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

As described in further detail herein, the present disclosure provides a solution to the above-referenced problems in the field of technology by providing dynamic network monitoring and packet validation in electronic environments using RPA and ML, which is designed to extract data from network data packets, use an ML engine to detect network event triggers, and assign an RPA bot to execute a requested network transmission protocol. The present disclosure solves the above technical problems by implementing the dynamic network monitoring and packet validation in electronic environments system—like that shown as system 130 herein—by harnessing RPA bots and ML to execute network transmission protocols. The system may extract data from network data packets received from at least one or more data sources to determine at least one network event trigger using the ML engine. In this respect, the system conserves computing resources by first determining network event trigger and then taking responsive action. The system also utilizes the ML engine to determine bot criteria based on the at least one network event trigger and assign an RPA bot based on at least the bot criteria. By assigning an RPA bot based on determined bot criteria, the system minimizes latency by utilizing RPA bots that have availability, bandwidth, or authorization to execute a given protocol. In addition, the system executes the network transmission protocol using the RPA bot. Utilization of an RPA bot to execute the network transmission protocol streamlines the protocol execution by reducing errors and by utilizing authorized RPA bots.

Accordingly, the present disclosure provides dynamic network monitoring and packet validation in electronic environments using RPA and ML. For instance, network transmission protocols require secure environments, authenticated users, and efficient computing resource allocation to minimize latencies. Continuously monitoring network activity to determine when to trigger a network transmission protocol requires large resource spend. Furthermore, ensuring and maintaining network security is a challenge with evolving threats and increased cross-environment interactions. The system resolves these challenges by utilizing an ML engine for dynamic network packet data monitoring and validation, as well as harnessing RPA for executing network transmission protocols.

What is more, the present disclosure provides a technical solution to a technical problem. As described herein, the technical problem includes dynamic network monitoring and packet validation in electronic environments using RPA and ML. The technical solution presented herein allows for secure, efficient, and autonomous networking monitoring, packet validation, network resources transfers, and threat notifications. In particular, the system for dynamic network monitoring and packet validation in electronic environments using RPA and ML is an improvement over existing solutions to the technical challenges, (i) with fewer steps to achieve the solution, thus reducing the amount of computing resources, such as processing resources, storage resources, network resources, and/or the like, that are being used (e.g., by utilizing an ML engine to detect network event triggers and determining responsive actions based on the network event triggers), (ii) providing a more accurate solution to problem, thus reducing the number of resources required to remedy any errors made due to a less accurate solution(e.g., by harnessing intelligently designated RPA bots to execute network transmission protocols), (iii) removing manual input and waste from the implementation of the solution, thus improving speed and efficiency of the process and conserving computing resources (e.g., by harnessing autonomous RPA bots to execute protocols), (iv) determining an optimal amount of resources that need to be used to implement the solution, thus reducing network traffic and load on existing computing resources (e.g., by monitoring network traffic and only executing responsive actions, such as protocols, based on a detected network event trigger). Furthermore, the technical solution described herein uses a rigorous, computerized process to perform specific tasks and/or activities that were not previously performed. In specific implementations, the technical solution bypasses a series of steps previously implemented, thus further conserving computing resources.

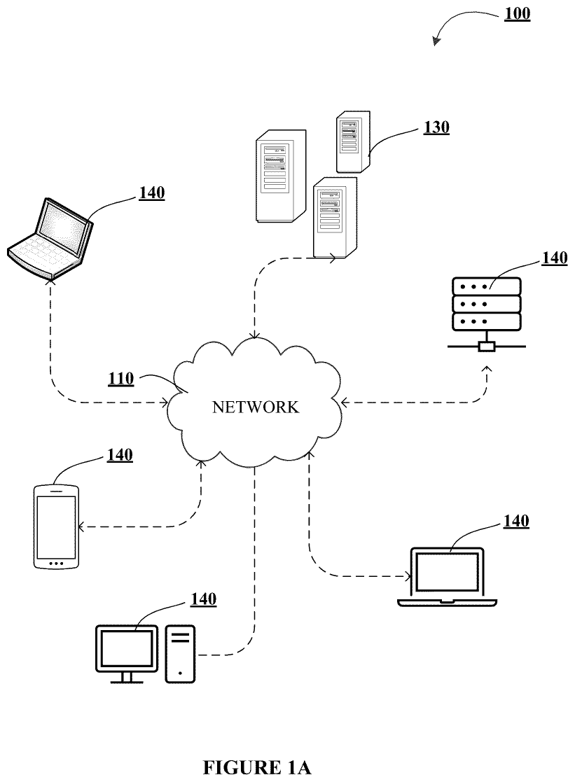

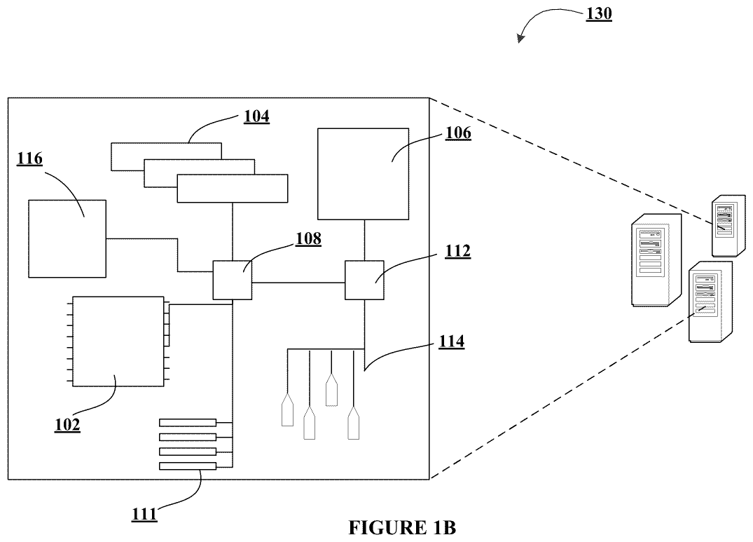

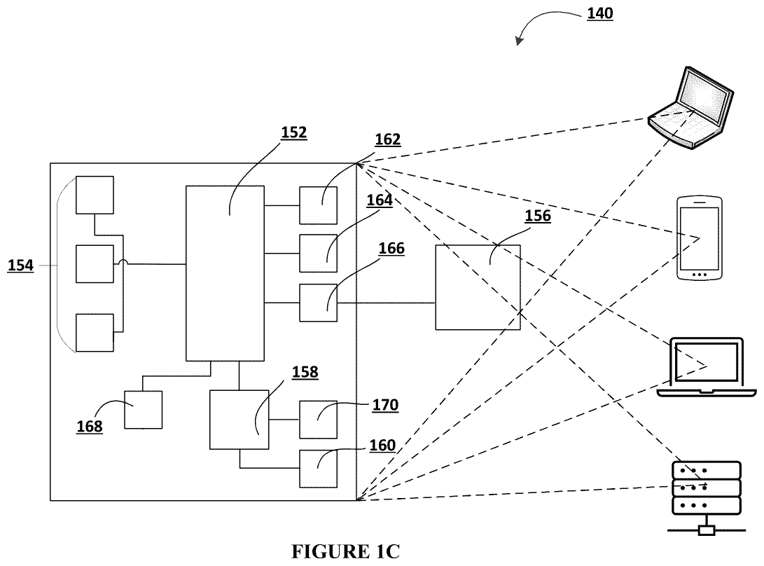

FIGS. 1A-1C illustrate technical components of an exemplary distributed computing environment for robotic process automation and machine learning for dynamic network monitoring and packet validation in electronic environments 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

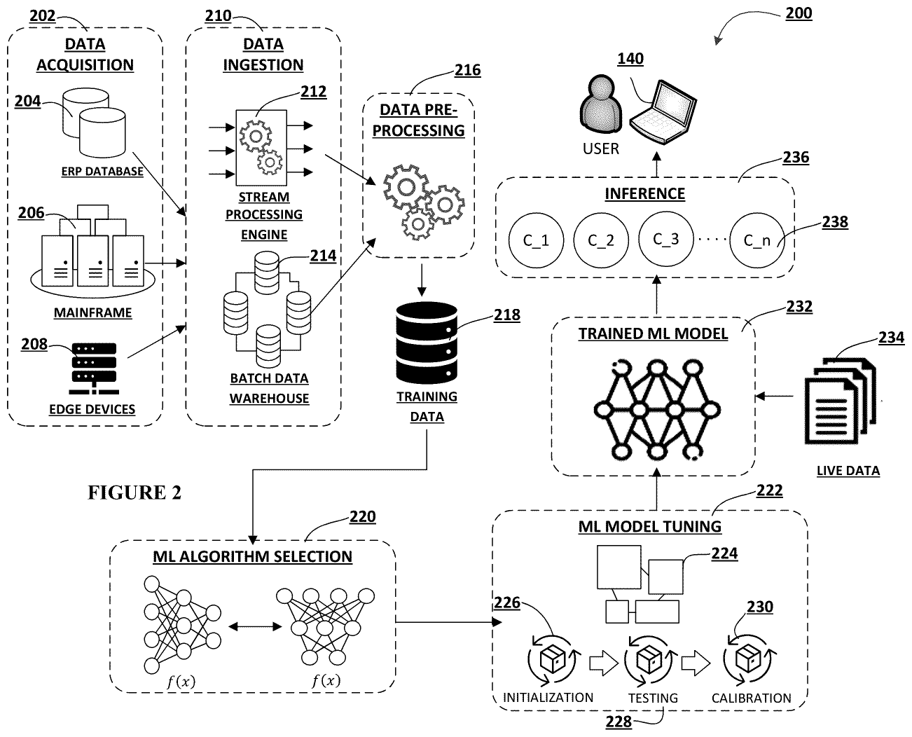

FIG. 2 illustrates an exemplary machine learning (ML) subsystem architecture 200, in accordance with an embodiment of the disclosure. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and /r combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

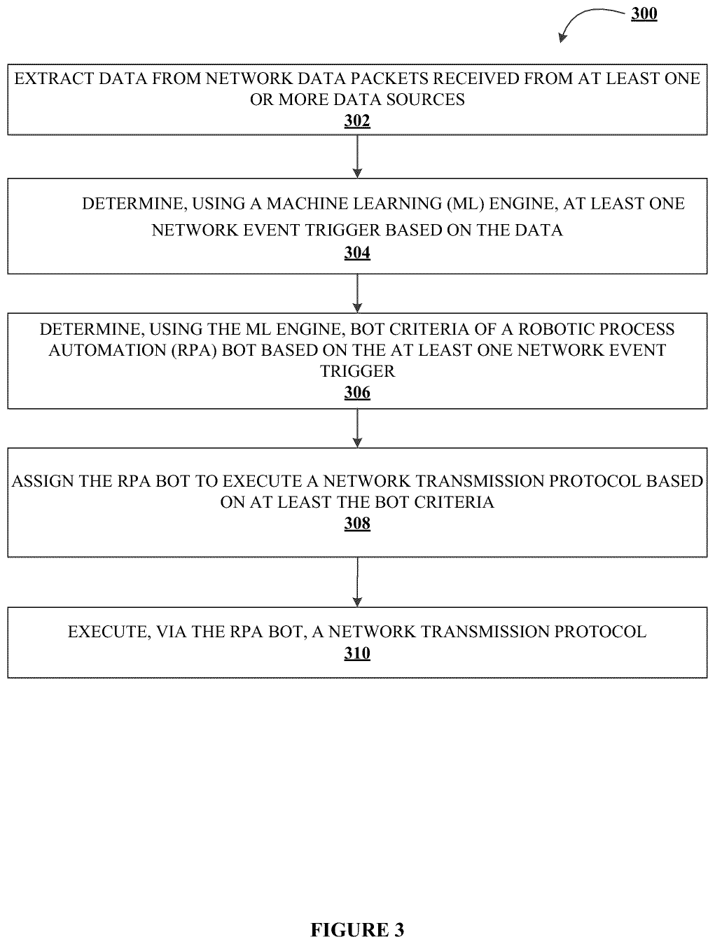

FIG. 3 illustrates a process flow 300 for robotic process automation and machine learning for dynamic network monitoring and packet validation in electronic environments, in accordance with an embodiment of the disclosure. In some embodiments, a system (e.g., similar to one or more of the systems described herein with respect to FIGS. 1A-1C) may perform one or more of the steps of process flow 300. For example, an RPA and ML for dynamic network monitoring and packet validation system (e.g., the system 130 described herein with respect to FIG. 1A-1C) may perform the steps of process flow 300. In some embodiments, an ML model and/or engine (e.g., such as an ML model like that described in FIG. 2) may perform some or all of the steps described in process flow 300.

As shown in block 302, the process flow 300 may include the step of extracting data from network data packets received from at least one or more data sources. In some embodiments, the network data packets may transmit via a communication channel, wherein the communication channel comprises encrypted transmissions, communications, and/or the like. In some embodiments, the network data packets may be transmitted across at least one electronic environment, network (e.g., internal network, external network, and/or the like), and/or the like. In some embodiments, the system may use an Extract, Transform, and Load (ETL) process to receive the network data packets from the at least one or more data sources, process the extracted data, and then store the extracted data in an internal data storage repository.

In some embodiments, the network data packets may comprise at least one of network resource transfer data, validation data, or network rule data associated with at least one of network resource transfer criteria, validation criteria, or network rule criteria. In some embodiments, network resource transfer criteria may comprise factors associated with at least one network resource transfer, such as a quantity, a sender identity (e.g., account holder name, account number, distributed ledger reference location, IP address, and/or the like), a recipient identity (e.g., account holder name, account number, distributed ledger reference location, IP address, and/or the like), currency, physical resources (e.g., precious metals, commodities, cash, and/or the like), digital tokens, cryptocurrency, digital tokens associated with a physical resource, non-fungible tokens, and/or the like.

In some embodiments, the validation criteria may comprise factors associated with smart contract execution, authentication, sender identity verification, recipient identity verification, network resource verification, quantity verification, token verification, and/or the like. In some embodiments, the network rule criteria may comprise may factors associated with at least one network, such as security (e.g., data security requirements), bandwidth requirements, performance, scalability, compatibility, encryption protocol, network topology, access controls, latency, and/or the like.

In some embodiments, the at least one or more data sources may comprise an internal data source comprising technical operational data associated with technical resources, efficiency, internal policy rules, and/or the like. In some embodiments, the at least one data source may comprise external regulatory data, rules data, compliance rules, and/or the like promulgated by at least one regulatory authority. The at least one regulatory authority may comprise Sarbanes-Oxley Act, Dodd-Frank Act, National Bank Act, regulations promulgated by the Office of the Comptroller of the Currency, Federal Trade Commission regulations, Securities and Exchange Commission regulations, General Data Protection Regulation, and/or the like, according to some embodiments of the disclosure. In some embodiments, the at least one regulatory authority may comprise a plurality of regulatory authorities, wherein the regulatory authorities originate from at least two jurisdictions. In some embodiments, the at least one data source may comprise a combination of external rules data and internal operational data.

As shown in block 304, the process flow 300 may include the step of determining, using a ML engine, at least one network event trigger based on the data. The at least one network event trigger may comprise a network resource transfer request, a network threat, a scheduled and/or predetermined network resource transfer trigger, and/or the like, according to some embodiments of the disclosure. In some embodiments, the ML engine may determine a plurality of network event triggers based on the data and may prioritize responsive actions and/or proactive actions based on at least the plurality of network event triggers. By way of non-limiting example, and in some embodiments, a responsive action in response to a network event trigger may comprise executing a network resource transfer, disabling network communications to a device, shutting down a network (e.g., a network associated with a device, a user, and/or the like), disabling network resource transfers, generating alerts, and/or the like. By way of non-limiting example, and in some embodiments, a proactive action in response to a network event trigger may comprise dynamic network data collection to detect network threats, encrypting all network data packet transmissions, enhancing network security access controls, and/or the like.

As shown in block 306, the process flow 300 may include the step of determining, using the ML engine, bot criteria of a robotic process automation (RPA) bot based on the at least one network event trigger. In some embodiments, the bot criteria may comprise data security requirements, security access (e.g., security access to applications, servers, accounts, electronic environments, networks, and/or computing systems), bandwidth of the RPA bot (e.g., available computing resources), status availability of the RPA bot, and/or the like. In some embodiments, the ML engine may receive data associated with at least one RPA bot, wherein the data associated with the at least one RPA bot may comprise RPA bot performance statistics, RPA bot data security authorizations, RPA bot data sequestration, RPA bot privacy configurations, RPA bot protocol allocation history data, RPA bot misappropriation data, and/or the like. Based on the RPA bot data, and in some embodiments the ML engine may determine bot criteria based on at least the network event trigger, data extracted from network data packets, request received from a network device, network threat data, and/or the like. In some embodiments, the ML engine may determine that at least one RPA bot has been misappropriated, suffered from security incident, suffered from data breach, and/or the like, and determine, based on the bot criteria, to not assign the at least one RPA bot to execute a network transmission protocol.

As shown in block 308, the process flow 300 may include the step of assigning the RPA bot to execute a network transmission protocol based on at least the bot criteria. In some embodiments, the system may comprise a plurality of RPA bots to execute various protocols, including without limitation the network transmission protocol. The bot criteria may be utilized for selecting and assigning any RPA bot to execute the network transmission protocol, in accordance with some embodiments of the disclosure. The RPA bots may be allocated and/or assigned to at least one electronic environment, at least one instance (e.g., development, test, production, and/or the like), at least one application server (e.g., virtual, physical, and/or the like), at least one database, at least one account, at least one application, at least one client computing agent, and/or the like, in accordance with some embodiments of the disclosure. In other embodiments, the RPA bots may only be allocated to a single electronic environment, instance, server, application, account and/or the like. In some embodiments of the disclosure, the RPA bots may be dynamically assigned across electronic environments, instances, applications, servers, and/or the like. By way of a non-limiting example, and in some embodiments, the ML engine may dynamically assign each RPA bot to a network transmission protocol based on the status availability, bandwidth, data security requirements, security access, and/or the like. In some embodiments, the RPA bots may be associated with an account to access a particular server, application, database, system account, and/or the like.

The status availability of the RPA bot may comprise an indicator indicating whether the RPA bot is currently allocated to a protocol (e.g., network transmission protocol, network threat protocol, rules data verification protocol, account generation protocol, identity registration protocol, and/or the like), wherein the RPA bot may be in an unassigned state, assigned state, pending state, and/or the like in some embodiments. In some embodiments, the RPA bot may be presently assigned (e.g., an assigned state) to a protocol, and thus unavailable to execute the network transmission protocol. In some embodiments, the RPA bot may have a protocol queue, wherein the protocol queue comprises a queue of protocols to execute when the RPA bot has availability. The protocol queue may be configured to prioritize pending protocols in the queue to reorder the execution of protocols by the RPA bots. In some embodiments, the ML engine, a user, and/or the like may reprioritize the protocol queue to modify the order of execution of protocols. In some embodiments, the bandwidth of the RPA bot may comprise a percentage of available computing resources to multi-task in the execution of a plurality of protocols simultaneously. In some embodiments, a low bandwidth of the RPA bot may be associated with longer protocol execution durations, latency delays, inefficient allocation of computing resources, and/or the like. In some embodiments, the system may reallocate an RPA bot with high bandwidth to execute a protocol (e.g., network transmission protocol, network threat protocol, rules data verification protocol, account generation protocol, identity registration protocol, and/or the like) if the RPA bot originally allocated to the protocol has low bandwidth, a large protocol queue, and/or the like. By load-balancing the allocation of RPA bots, the system resolves the technical problems of computing resource allocation, execution efficiency, and system latencies.

As shown in block 310, the process flow 300 may include the step of executing, via the RPA bot, a network transmission protocol. In some embodiments, the network transmission protocol may comprise a network resource transfer, network threat protocol, rules data verification protocol, account generation protocol, identity registration protocol, and/or the like. In some embodiments, the RPA bot may determine a threat (e.g., data security, access control failure, breach of the electronic environment, misappropriation of network resources, and/or the like) and intercept the network transmission protocol. When the network transmission protocol is intercepted, the system may capture the threat in a threat log and generate an alert comprising the threat log, in some embodiments.

In some embodiments, a network resource transfer may comprise authenticating a network resource transfer request via multifactor authentication, accessing network resources for transferring, accessing a sending account and a receiving account, receiving and encrypting data associated with the network transfer request, executing a transfer transmission from a sender to a recipient, determining a success threshold of the transfer transmission, and generating an alert comprising the success threshold. In some embodiments, the success threshold may be a binary indicator of success or failure, a percentage associated with a percentage of network resources successfully transmitted during the network resource transfer, a qualitative descriptor associated with network resources successfully transmitted during the network resource transfer, and/or the like.

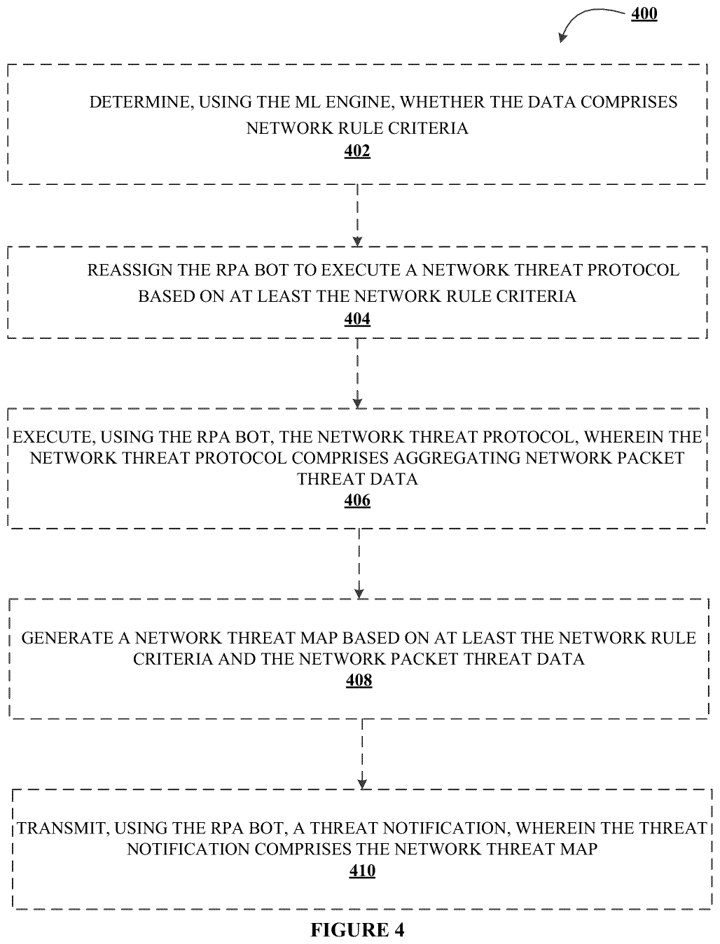

FIG. 4 illustrates a process flow 400 for transmitting, using the RPA bot, a threat notification, wherein the threat notification comprises a network threat map, in accordance with an embodiment of the disclosure. In some embodiments, a system (e.g., similar to one or more of the systems described herein with respect to FIGS. 1A-1C) may perform one or more of the steps of process flow 400. For example, an RPA and ML for dynamic network monitoring and packet validation system (e.g., the system 130 described herein with respect to FIG. 1A-1C) may perform the steps of process flow 400. In some embodiments, an ML model and/or engine (e.g., such as an ML model like that described in FIG. 2) may perform some or all of the steps described in process flow 400.

As shown in block 402, the process flow 400 may include the step of determining, using the ML engine, whether the data comprises network rule criteria. In some embodiments, network rule criteria may comprise rules data promulgated by an external regulatory authority and/or an internal regulatory authority, network configurations associated with network access controls, permissions requirements, encryption requirements, data security requirements, privacy requirements, personally-identifiable information (PII) rule criteria, network resource, criteria associated with ownership and/or custodianship, resource size restrictions, network resource types (e.g., cash equivalents, cryptocurrency, funds, digital tokens, tokens, securities, financial instruments, applications, networking applications, networking hardware, routers, switches, software code, RPA executables, and/or the like), network resource restrictions, geographic restrictions on network resource transfers, and/or the like. In some embodiments, the system will query the location (e.g., geographic, virtual address, account associated with an entity), of the sender and of the recipient, and the ML engine may determine whether a restriction on network resource transfers exist based on at least the location of the sender and/or of the recipient. By way of a non-limiting example, and in some embodiments, the ML engine may determine that a location restriction exists and then the system may intercept the network resource transfer, generate a log file, and/or generate an alert comprising the log file, wherein the alert recipients may comprise users, stakeholders, regulatory authorities, and/or the like.

As shown in block 404, the process flow 400 may include the step of reassigning the RPA bot to execute a network threat protocol based on at least the network rule criteria. In some embodiments, the ML engine may reassign the RPA bot to execute a network threat protocol based on at least the network rule criteria, wherein the RPA bot may have been previously assigned to execute a different protocol (e.g., network transmission protocol, network threat protocol, rules data verification protocol, account generation protocol, identity registration protocol, and/or the like). In some embodiments of the disclosure, the RPA bot may be reassigned by a user-generated request. In some embodiments, the reassigning of the bot may be based on network rule criteria, bot criteria, network resources, network transfer request, availability of the RPA bot and/or a plurality of RPA bots, and/or the like.

As shown in block 406, the process flow 400 may include the step of executing, using the RPA bot, the network threat protocol, wherein the network threat protocol comprises aggregating network packet threat data. In some embodiments, the network packet threat data are aggregated via a private network channel, wherein the private network channel comprises a secure socket layer, encrypted communications, and/or the like. The network packet threat data may undergo pre-aggregation processing, wherein the pre-aggregation processing may comprise encryption, ETL processing, data cleansing, and/or the like. The network packet threat data may comprise a collection of data across the electronic environment comprising threats, according to some embodiments. In such a configuration, the threats may comprise vulnerabilities associated with the network transfer request, network transfer protocol, bot criteria, data security requirements, network access, security permissions, misappropriation actions by unauthorized actors, security compromised RPA bot, and/or the like. In some embodiments, the network packet threat data may be associated with at least one network device, user device, network, electronic environment, network resource sender, network resource recipient, RPA bot, and/or the like. In some embodiments, a data aggregator may collect network packet threat data to generate aggregated network packet threat data and transmit the aggregated network packet threat data via network data packets to the system. In some embodiments, the system may process the received network packet threat data, such as executing decryption, data extraction, and/or the like.

As shown in block 408, the process flow 400 may include the step of generating a network threat map based on at least the network rule criteria and the network packet threat data. In some embodiments, the ML engine may generate the network threat map. In some embodiments, at least one RPA bot may generate the network threat map by executing a network threat map protocol, wherein the network threat map protocol may comprise generating a directed graph comprising nodes associated with network resources and vectors associated with the network packet threat data. In some embodiments of the disclosure, the ML engine may map the network packet threat data to the network rule criteria to generate a network threat map. In some embodiments, the network threat map may indicate the relationships between the network rule criteria and network packet threat data, such as including but not limited to showing the relationships between nodes indicating each network threat criteria and network packet threat data, with vectors indicating the relationships between each node, according to some embodiments. In some embodiments, the network threat map may indicate vulnerabilities within the electronic environment. The vulnerabilities may comprise vulnerabilities associated with network resources, at least one network resource transfer protocol, access control requirements, regulatory authority, malicious actions propagated by a bad actor (e.g., maliciously intercepted network resource transfer protocol), compromised personally identifiable information, and/or the like. The network threat map may be updated in real time based on continuously received rules data, network rule criteria, and/or aggregated network packet threat data, according to some embodiments. In such a configuration, changes in network rule criteria and/or aggregated network packet threat data may modify the rule threat map dynamically as conditions evolve. In some embodiments, the ML engine may generate recommendations for the RPA bot to execute at least one network threat technical remediation protocol. In such configuration, by way of a non-limiting example, the RPA bot may execute a network threat technical remediation protocol to mitigate unauthorized access by a bad actor, increase security requirements for network transmission protocols, require re-authentication by a network resource transfer sender and/or a network resource transfer recipient, encrypt network data packet transmissions, and/or the like.

As shown in block 410, the process flow 400 may include the step of transmitting, using the RPA bot, a threat notification, wherein the threat notification comprises the network threat map. In some embodiments, the system and/or the ML engine may generate a notification associated with the network threat map. The notification may comprise an email, text message, push-notification, alert, and/or the like. In some embodiments, the notification may require authentication (e.g., multi-factor authentication, one-time password, physical attribute authentication, authenticator app, PIN code, and/or the like) to access and read the notification. In some embodiments, the notification may comprise an encrypted message which may require a decrypting program to access and read the notification. In some embodiments of the disclosure, the notification may be transmitted to users, user devices associated with managers and/or operators of user devices and/or network devices associated with the threat map. In some embodiments, the notification may comprise recommendations generated by the system, the ML engine, and/or the like for remediating network threats described in the network threat map. The recommendations may comprise enhancing security requirements, remediating data security requirements incidents, mitigating network security incidents, removing an authorized actor's access, and/or the like.

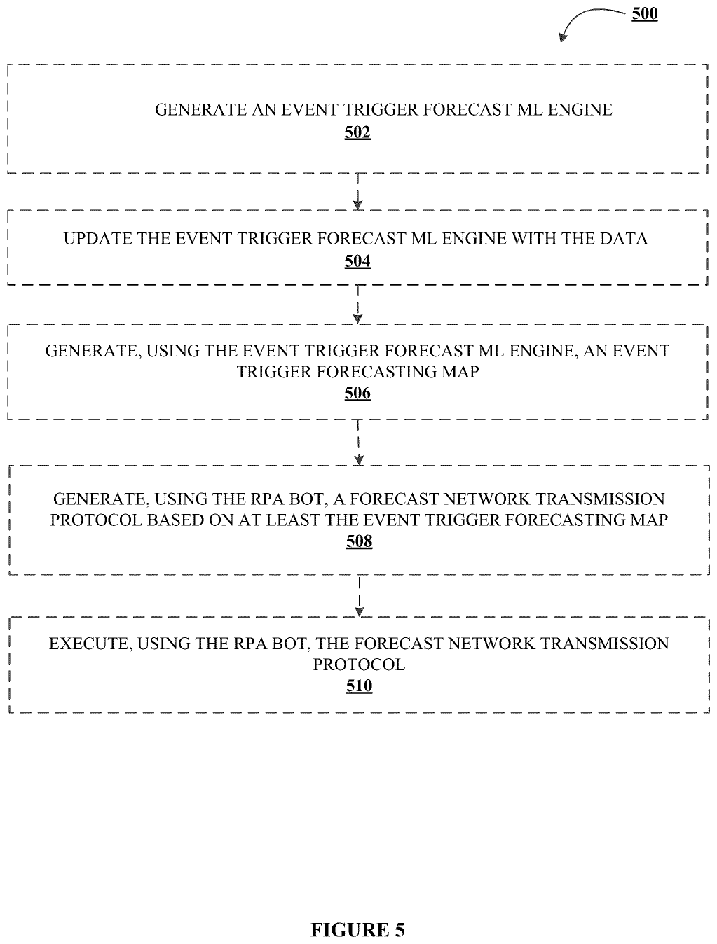

FIG. 5 illustrates a process flow 500 for executing, using the RPA bot, a forecast network transmission protocol, in accordance with an embodiment of the disclosure. In some embodiments, a system (e.g., similar to one or more of the systems described herein with respect to FIGS. 1A-1C) may perform one or more of the steps of process flow 500. For example, an RPA and ML for dynamic network monitoring and packet validation system (e.g., the system 130 described herein with respect to FIG. 1A-1C) may perform the steps of process flow 500. In some embodiments, an ML model and/or engine (e.g., such as an ML model like that described in FIG. 2) may perform some or all of the steps described in process flow 500.

As shown in block 502, the process flow 500 may include the step of generating an event trigger forecast ML engine. In some embodiments, the event trigger forecast ML engine comprises an ML engine that may forecast event triggers based on at least the data, historical data, network packet threat data, and/or the like. The event trigger forecast ML engine may be pre-trained with historical data, trained continuously using real-time data, and/or the like. In some embodiments, the event trigger forecast ML engine may predict future event triggers and/or network event triggers based on historical data and/or real-time data, wherein the real-time data comprises known network event triggers, network packet threat data, known threats (e.g., network security, data security, unauthorized access, malware, security incidents, and/or the like).

As shown in block 504, the process flow 500 may include the step of updating the event trigger forecast ML engine with the data. In some embodiments, the event trigger forecast ML engine may update based on data received by the system (e.g., the data, historical data, network packet threat data, and/or the like) and the network threat map. In some embodiments of the disclosure, the updates to the event trigger forecast ML engine may occur in real time as data is continuously received and/or the network threat map updates continuously. In some embodiments, updates to the event trigger forecast ML engine may occur at set intervals, execute via batch processing, and/or the like. After receiving data and updating the event trigger forecast ML engine, the event trigger forecast ML engine may undergo a retraining process to refine at least the configurations, modes, and/or the like of the event trigger forecast ML engine, according to some embodiments. In some embodiments, the updates to the event trigger forecast ML engine may occur by an end user, by the system, by an event trigger forecast ML engine feedback loop, and/or the like. In some embodiments, the event trigger forecast ML engine feedback loop may analyze machine learning output from the event trigger forecast ML engine to determine issues, generate updates to the event trigger forecast ML engine, implement the updates, and/or the like.

As shown in block 506, the process flow 500 may include the step of generating, using the event trigger forecast ML engine, an event trigger forecasting map. In some embodiments, the event trigger forecasting map comprising groupings of potential event triggers that may comprise network event triggers based on known event triggers, emerging event triggers, historical event triggers, and/or the like. In some embodiments of the disclosure, the event trigger forecasting map may comprise forecast threats, forecast network resource transfer requests, forecast network resource transfer request authentications, ML engine training requests, forecast distributed network resource transfers and/or forecast protocols, including without limitation at least one network transmission protocol, network threat protocol, forecast network transmission protocol, rules data verification protocol, and/or account generation protocol.

As shown in block 508, the process flow 500 may include the step of generating, using the RPA bot, a forecast network transmission protocol based on at least the event trigger forecasting map. In some embodiments the forecast network transmission protocol may comprise a network transmission protocol based on at least the event trigger forecasting map. By way of non-limiting example, and in some embodiments, the event trigger forecasting map may indicate that a protocol (e.g., network transmission protocol, network threat protocol, rules data verification protocol, account generation protocol, identity registration protocol, and/or the like) executes via a request received from at least one device, wherein the request may be interval-based, based on a numerical network threshold (e.g., percentage, percentage change, whole number, decimal number, and/or the like), based on a qualitative network descriptor, and/or the like. In such a configuration, the event trigger forecasting map may specify to generate a network transmission protocol via a forecast network transmission protocol and/or the event trigger forecast ML engine may determine to generate such a forecast network transmission protocol based on changing conditions, received data, data promulgated by a regulatory authority, and/or the like.

As shown in block 510, the process flow 500 may include the step of executing, using the RPA bot, the forecast network transmission protocol. In some embodiments, the event trigger forecast ML engine may allocate the RPA bot to execute the forecast network transmission protocol. In some embodiments of the disclosure, the RPA bot may be allocated and/or assigned via request received from at least one device, ML engine, and/or the system.

In some embodiments, the forecast network transmission protocol may comprise a network resource transfer, network threat protocol, rules data verification protocol, account generation protocol, identity registration protocol, and/or the like. In some embodiments, the RPA bot may identify at least one additional network event trigger (e.g., network resource transfer, data security incident, access control failure, breach of the electronic environment, misappropriation of network resources, and/or the like) while executing the forecast network transmission protocol and intercept the forecast network transmission protocol. The forecast network transmission protocol may comprise a responsive action to an emerging threat, pending and/or failed network resource transfer, detected known network vulnerability, and/or the like, according to some embodiments. When the forecast network transmission protocol is intercepted, the system may capture the cause of the interception in a forecast network transmission protocol threat log and generate an alert comprising the forecast network transmission protocol threat log, in some embodiments.

In some embodiments, the forecast network transmission protocol may comprise authenticating via multifactor authentication, accessing network resources for transferring, accessing a sending account and a receiving account, receiving and encrypting data associated with the forecast network transmission protocol, executing a network resource transfer from a sender to a recipient, determining a success threshold of the network resource transfer, and generating an alert comprising the success threshold. In some embodiments, the success threshold may be a binary indicator of success or failure, a percentage associated with a percentage of network resources successfully transmitted during the network resource transfer, a qualitative descriptor associated with network resources successfully transmitted during the network resource transfer, and/or the like.

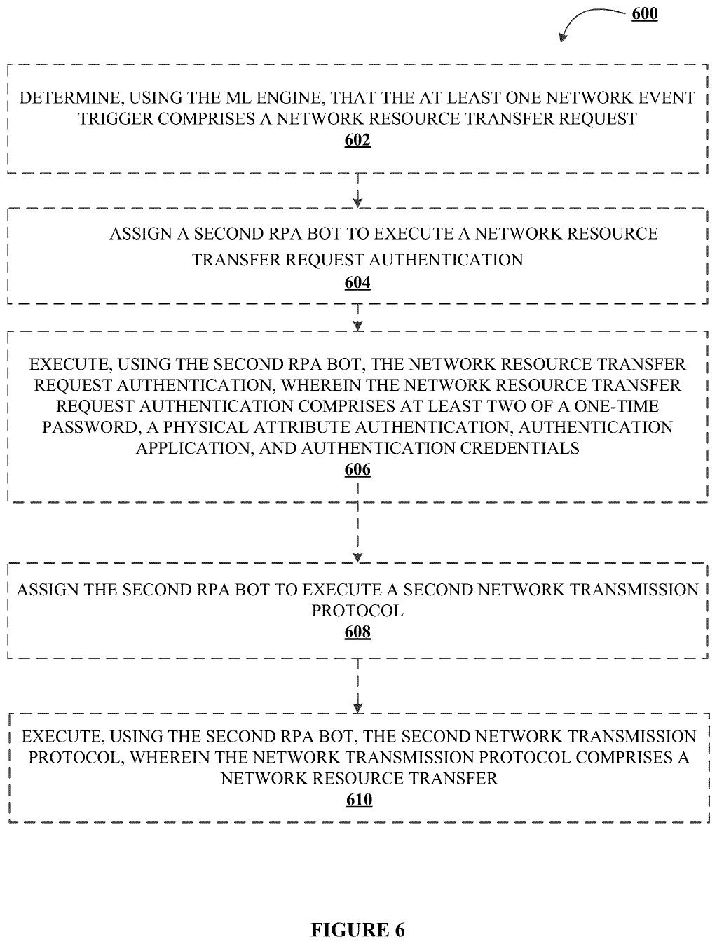

FIG. 6 illustrates a process flow 600 for executing, using a second RPA bot, a network resource transfer request authentication and a network transmission protocol, in accordance with an embodiment of the disclosure. In some embodiments, a system (e.g., similar to one or more of the systems described herein with respect to FIGS. 1A-1C) may perform one or more of the steps of process flow 600. For example, an RPA and ML for dynamic network monitoring and packet validation system (e.g., the system 130 described herein with respect to FIG. 1A-1C) may perform the steps of process flow 600. In some embodiments, an ML model and/or engine (e.g., such as an ML model like that described in FIG. 2) may perform some or all of the steps described in process flow 600.

As shown in block 602, the process flow 600 may include the step of determining, using the ML engine, that the at least one network event trigger comprises a network resource transfer request. In some embodiments, the at least one network event trigger may comprise a request from at least one device associated with a user, an account, and/or the like. In some embodiments, the at least one network event trigger is generated by the system, forecast network ML engine, the ML engine, and/or the like. The at least one event trigger may comprise data extracted from a network data packet, wherein the data comprises a trigger for a network resource transfer, network threat assessment, network threat remediation, disconnecting at least one device from a network, and/or shutting down at least one network, in some embodiments.

As shown in block 604, the process flow 600 may include the step of assigning a second RPA bot to execute a network resource transfer request authentication. In some embodiments, the RPA bot may be unavailable to execute the network resource request authentication. By way of non-limiting example, and in some embodiments, the RPA bot may lack required configurations (e.g., lacking software and/or hardware requirements, lack of security access, improper data security requirements, and/or the like) for executing the network resource transfer request authentication. In some embodiments, the system may assign the second RPA bot from a plurality of RPA bots. The second RPA bot may be selected at random, by the ML engine, and/or based on its availability, bandwidth, security access, data security requirements, execution efficiency, and/or the like.

As shown in block 606, the process flow 600 may include the step of executing, using the second RPA bot, the network resource transfer request authentication, wherein the network resource transfer request authentication comprises at least two (e.g., multi-factor authentication) of a one-time password, a physical attribute authentication, authentication application, and authentication credentials. In some embodiments, the network resource transfer request may specify which of the foregoing multi-factor authentication methods are required for the network resource transfer request authentication. In some embodiments, the system may select the multi-factor authentication methods based on the at least one network event trigger, electronic environment, known threats and/or emerging threats, numerical value associated with the network resource transfer, and/or the like. The multi-factor authentication methods may be randomly selected, selected by the ML engine, and/or the like, according to some embodiments. By way of non-limiting example, and in some embodiments, when the network resource transfer request comprises at least two networks, the system may determine that heightened authentication methods may be required and may select authentication methods associated with heightened security requirements.

As shown in block 608, the process flow 600 may include the step of assigning the second RPA bot to execute a second network transmission protocol. In some embodiments, the second RPA bot may have availability, bandwidth, security access, data security requirements, execution efficiency, and/or the like to execute a second network transmission protocol, even accounting for the execution of the network resource transfer request authentication. In some embodiments, the second RPA bot may be assigned the execute the second network transmission protocol by the system, ML engine, via user request received from at least one device, and/or the like. Once the second RPA bot has been assigned to execute the second network transmission protocol, the status indicator of the second RPA bot may update to assigned, and thus make it unavailable for executing other protocols, according to some embodiments. In some embodiments, the second network transmission protocol may be added to the second RPA bot protocol queue for execution at a delayed time. The second RPA bot protocol queue may be reprioritized to prioritize an earlier execution of the second network transmission protocol.

As shown in block 610, the process flow 600 may include the step of executing, using the second RPA bot, the second network transmission protocol, wherein the network transmission protocol comprises a network resource transfer. In some embodiments, the second network transmission protocol may comprise the transfer of network resources as specified by the network transmission protocol (e.g., a first network transmission protocol in some embodiments). In some embodiments, a second network transmission protocol success threshold of the network resource transfer may be determined by the system, second RPA bot, ML engine, and/or the like. The second network transmission protocol success threshold may comprise a binary indicator of success or failure, a percentage associated with a percentage of network resources successfully transmitted during the second network resource transmission protocol, a qualitative descriptor associated with network resources successfully transmitted during the second network resource transmission protocol, and/or the like. An alert may be generated by the second RPA bot, ML engine, system, and/or the like, wherein the alert may comprise the second network transmission protocol success threshold, in some embodiments.

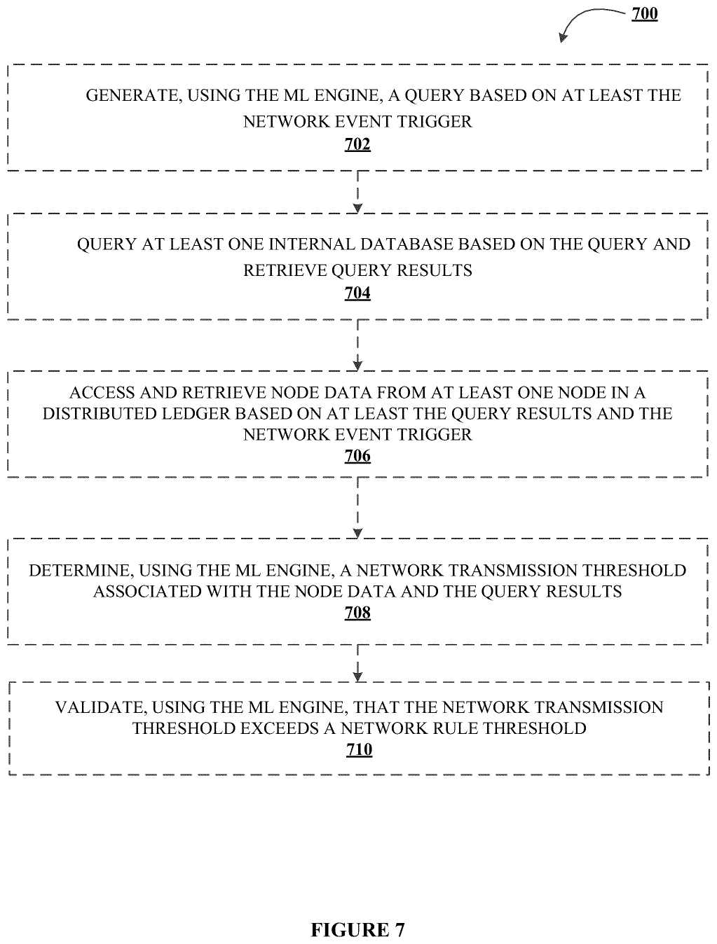

FIG. 7 illustrates a process flow 700 for validating, using the ML engine, that a network transmission threshold exceeds a network rule threshold, in accordance with an embodiment of the disclosure. In some embodiments, a system (e.g., similar to one or more of the systems described herein with respect to FIGS. 1A-1C) may perform one or more of the steps of process flow 700. For example, an RPA and ML for dynamic network monitoring and packet validation system (e.g., the system 130 described herein with respect to FIG. 1A-1C) may perform the steps of process flow 700. In some embodiments, an ML model and/or engine (e.g., such as an ML model like that described in FIG. 2) may perform some or all of the steps described in process flow 700.

As shown in block 702, the process flow 700 may include the step of generating, using the ML engine, a query based on at least the network event trigger. In some embodiments the query may be based on the network event trigger, query data transmitted by at least one user device, network data analyzed by the ML engine, and/or the like. In some embodiments, the network event trigger may comprise query instructions associated with at least one of a network transmission threshold and a network rule threshold. According to some embodiments of the disclosure, the query instructions may comprise target data to include in the query, at least one data source to query, and/or the like.

As shown in block 704, the process flow 700 may include the step of querying at least one internal database based on the query and retrieve query results. In some embodiments, the query is executed by the ML engine, an RPA bot, the system, and/or the like. In some embodiments, the RPA bot, ML engine, and/or system may retrieve the query, execute the query, retrieve the query results, store the results in an internal query database, and/or the like. In accordance with some embodiments of the disclosure. At least one internal database may be queried, wherein the at least one internal database comprises at least one of network transmission data, network transmission threshold data, network rule data, network rule threshold data, distributed ledger data, node data, and/or the like, according to some embodiments of the disclosure. In some embodiments, the at least one internal database may comprise a relational database, a peer-to-peer distributed ledger, and/or the like.

As shown in block 706, the process flow 700 may include the step of accessing and retrieving node data from at least one node in a distributed ledger based on at least the query results and the network event trigger. The query results and network event trigger may comprise a reference address for the at least one node on the distributed ledger, according to some embodiments. In some embodiments, the system, ML engine, RPA bot, and/or like may access and retrieve node data from at least one node in a distributed ledger based on at least the query results and the network event trigger. In some embodiments, the RPA bot, ML engine, system, and/or like may decrypt the node data stored in the at least one node to access and analyze the node data. The node data may comprise at least one of network transmission data, network transmission threshold data, network rule data, network rule threshold data, and/or the like, according to some embodiments of the disclosure. In some embodiments, the node data may comprise distributed network resource transfer data, wherein the distributed network resource transfer data may comprise distributed network resource transfers. By way of non-limiting example, and in some embodiments, the node data from the at least one node may comprise at least one distributed ledger transaction recorded on the distributed ledger. According to some embodiments, the at least one distributed ledger transaction may comprise a transfer of tokens, non-fungible tokens, cryptocurrency, financial instruments, funds, digital tokens, digital tokens associated with physical objects, physical objects, and/or the like.

As shown in block 708, the process flow 700 may include the step of determining, using the ML engine, a network transmission threshold associated with the node data and the query results. In some embodiments, the ML engine, RPA bot, system, and/or the like may access data associated with at least one distributed ledger transaction data stored in an internal database (hereinafter referred to as “internal node transaction data”). In some embodiments of the disclosure, the network transmission threshold may comprise a comparison of the internal node transaction data to the node data. According to some embodiments, the ML engine, RPA bot, and/or system may determine the network transmission threshold based on internal node transaction data, node data, query results, and/or the like. If the comparison of the internal node transaction data and the node data fails, the system may the system may generate a network transmission threshold error log and transmit a notification comprising the network transmission threshold error log to at least one user, network manager, and/or regulatory authority for error remediation, in some embodiments. In some embodiments, the ML engine may generate and transmit remediation recommendations to mitigate the network transmission threshold error log.

As shown in block 710, the process flow 700 may include the step of validating, using the ML engine, that the network transmission threshold exceeds a network rule threshold. In some embodiments, the network rule threshold comprises a confidence threshold associated with the network transmission threshold. The network rule threshold may comprise regulatory data (e.g., internal and/or external) associated with rule parameters, in some embodiments. In some embodiments of the disclosure, the rule parameters may comprise requirements for the network transmission threshold, wherein the requirements comprise a success indicator associated with the network transmission threshold, interval frequency for executing the network transmission threshold, mandatory notifications, and/or the like. The network rule threshold may determine the frequency intervals of network transmission threshold determinations (e.g., real-time, continuously, daily, weekly, monthly, quarterly, yearly, and/or the like). According to some embodiments, the network rule threshold may be updated continuously, be set at predetermined intervals, and/or be fixed by a regulatory authority. The ML engine may validate the network transmission thresholds exceeds the network rule threshold continuously, on set intervals, via request transmitted by at least one user device, and/or the like, according to some embodiments. In some embodiments the ML engine, RPA bot, and/or the like may execute a threat assessment based on the network rule threshold. If the network rule threshold is exceeded by the network transmission threshold and/or the threat assessment does not identify threats associated with the network rule threshold, the RPA bot may generate and transmit a report, wherein the report comprises the validation that the network rule threshold is exceeded by the network transmission threshold and/or the threat assessment did not identify threats associated with the network rule threshold, in some embodiments. If the network rule threshold is not exceeded by the network transmission threshold and/or the threat assessment identifies threats associated with the network rule threshold, the system may generate a network rule threshold error log and transmit a notification comprising the network rule threshold error log to at least one user, manager, and/or regulatory authority for error remediation, in some embodiments. In some embodiments, the ML engine may generate and transmit remediation recommendations to mitigate the network rule threshold error log.

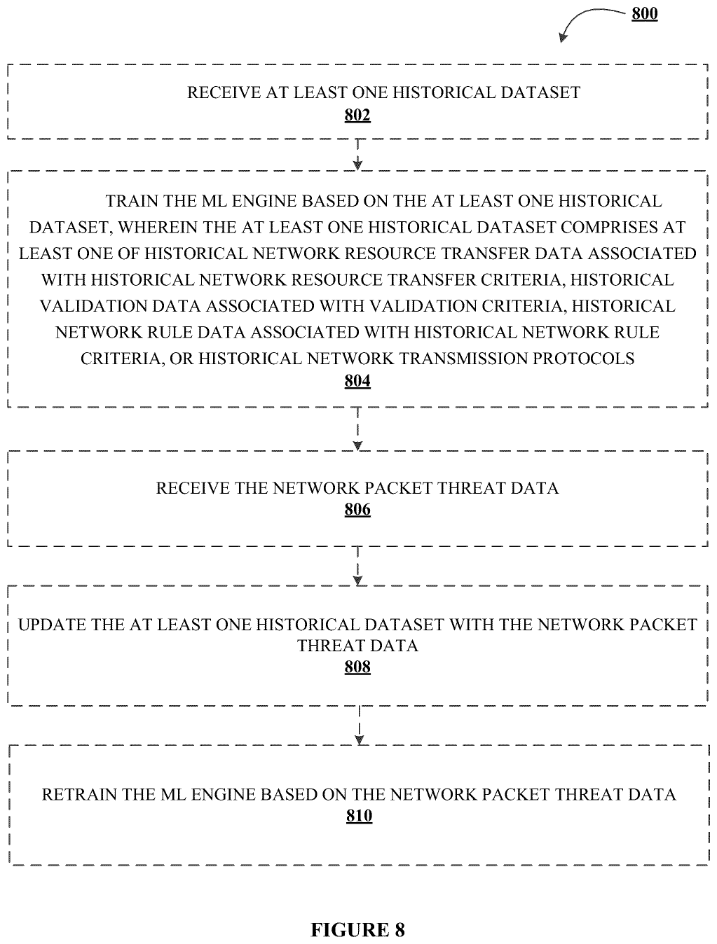

FIG. 8 illustrates a process flow 800 for training and retraining the ML engine based on at least one historical dataset and network packet threat data, in accordance with an embodiment of the disclosure. In some embodiments, a system (e.g., similar to one or more of the systems described herein with respect to FIGS. 1A-1C) may perform one or more of the steps of process flow 800. For example, an RPA and ML for dynamic network monitoring and packet validation system (e.g., the system 130 described herein with respect to FIG. 1A-1C) may perform the steps of process flow 800. In some embodiments, an ML model and/or engine (e.g., such as an ML model like that described in FIG. 2) may perform some or all of the steps described in process flow 800.

As shown in block 802, the process flow 800 may include the step of receiving at least one historical dataset. The historical dataset may be stored in an internal data repository, hosted externally by a regulatory authority, and/or the like. In some embodiments, the system may collect, compile, and/or aggregate historical data to create the historical dataset and may store the historical dataset in an internal data repository. In such a configuration, the system may access and retrieve the historical dataset each time the ML engine may be trained. In some embodiments, the system may receive the historical dataset at set internals and/or via on-demand request generated by the ML engine, a user, an ML engine training controller, and/or the like. In some embodiments, the system may only receive a subset of data contained within the historical dataset based on training requirements associated with an ML engine training request generated by the system, user, and/or the like. In a non-limiting example, and in some embodiments, the system may generate a request to train the ML engine on historical network transmission protocol data associated with users interacting within an internally-hosted electronic environment, and may only receive a subset of the historical dataset comprising the network transmission protocol data associated with users interacting within the internally-hosted electronic environment (e.g., the subset may not include historical network transmission protocol data associated with users interacting within externally-hosted electronic environments). By training the ML engine on only a subset of the historical dataset based on the most material and/or relevant data, the system conserves computing resources, minimizes energy expenditures, and enhances the ML engine performance. In some embodiments, the system may receive the entire at least one historical dataset.

As shown in block 804, the process flow 800 may include the step of training the ML engine based on the at least one historical dataset, wherein the at least one historical dataset comprises at least one of historical network resource transfer data associated with historical network resource transfer criteria, historical validation data associated with validation criteria, historical network rule data associated with historical network rule criteria, or historical network transmission protocols. In some embodiments, the historical network resource transfer data associated with historical network resource transfer criteria may comprise historical criteria promulgated by a user, regulatory authority, entity, user device, network administrator, and/or the like, including without limitation data security requirements, data transmission latency requirements, data transmission efficiency requirements, authentication requirements, geolocation requirements, regulatory requirements, network resource type requirements, network resource quantity requirements, and/or the like. In some embodiments, the historical network resource transfer data associated with historical network resource transfer criteria may comprise historical factors associated with historical network resource transfers, including without limitation a quantity, a sender identity (e.g., account holder name, account number, distributed ledger reference location, IP address, and/or the like), a recipient identity (e.g., account holder name, account number, distributed ledger reference location, IP address, and/or the like), currency, physical resources (e.g., precious metals, commodities, cash, and/or the like), digital tokens, cryptocurrency, digital tokens associated with a physical resource, non-fungible tokens, resources, network resources, and/or the like.

According to some embodiments, the historical network rule data associated with historical network rule criteria may comprise historical factors associated with at least one network, such as security (e.g., data security requirements, permissions requirements, authorization requirements), network bandwidth requirements, network performance criteria, scalability, compatibility (e.g., applications, network devices, user devices, and/or the like), encryption protocol, network topology, network access controls, network latency requirements, authorized user access criteria, and/or the like.

In some embodiments of the disclosure, the historical validation data associated with validation criteria may comprise historical factors associated with smart contract execution, authentication, sender identity verification, recipient identity verification, network resource verification, quantity verification, token verification, resource transfer validation, node data validation, and/or the like.

As shown in block 806, the process flow 800 may include the step of receiving the network packet threat data. In some embodiments, receiving the network packet threat data may comprise receiving network data packets comprising the network packet threat data. In some embodiments, a data aggregator may collect network packet threat data to generate aggregated network packet threat data and transmit the aggregated vulnerability data via network data packets to the system. In some embodiments, the data aggregator may pre-process the network packet threat data, such as data cleansing, encrypting, and/or executing an ETL process. In some embodiments, the system may process the received network data packets, such as executing decryption, data extraction, and/or the like.

As shown in block 808, the process flow 800 may include the step of updating the at least one historical dataset with the network packet threat data. In some embodiments, the network packet threat data may be attached to the at least one historical dataset. In such a configuration, an ETL process may be executed to transmit the network packet threat data dataset to the same data storage repository as the at least one historical dataset.

As shown in block 810, the process flow 800 may include the step of retraining the ML engine based on the network packet threat data. The retraining step may be executed via feedback loop for continuous retraining and/or the retraining may occur via batch jobs, according to some embodiments. In some embodiments, the ML engine may refine itself by revising its weights and other such decision factors to improve accuracy, speed, and minimize errors, based on ML engine training confidence threshold. In some embodiments, the system may determine the ML engine training confidence threshold, and if the ML engine training confidence threshold is below a given confidence threshold, the system may trigger retraining of the ML engine. In some embodiments, if new resource transfer criteria, network rule criteria, validation criteria, and/or network packet threat data are generated and/or received by the system (hereinafter referred to as “new training factors”), then the system may trigger in real-time retraining of the ML engine based on the new training factors. By constantly monitoring for new training factors and triggering a responsive real-time retraining, the system provides a technical solution to the challenge of monitoring new training factors and changing network conditions, and adjusting the system dynamically.

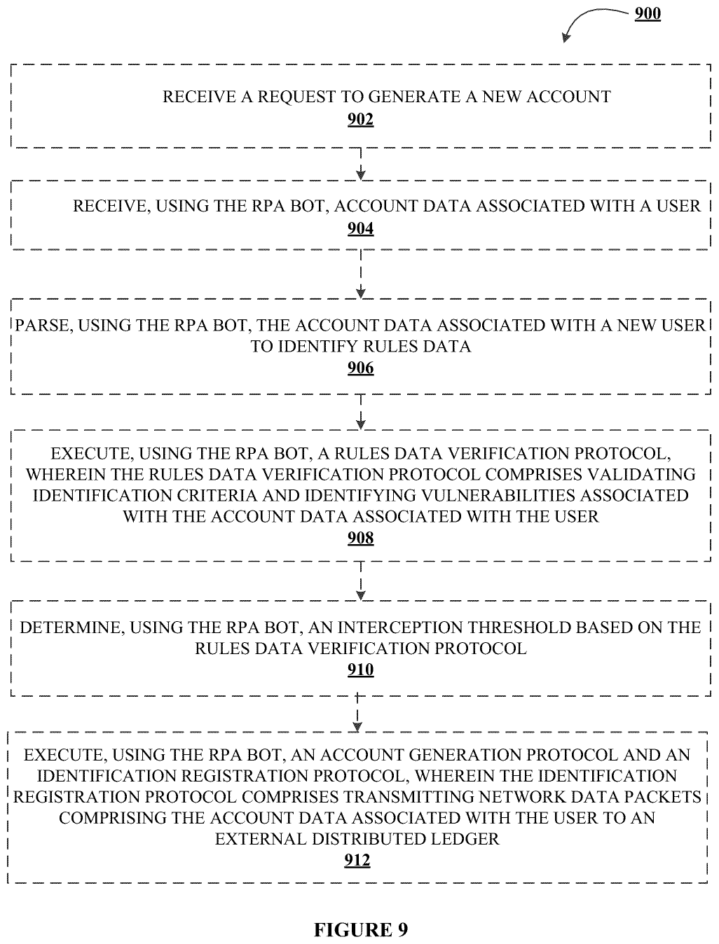

FIG. 9 illustrates a process flow 900 for executing, using the RPA bot, a rules data verification protocol, an account generation protocol, and an identification registration protocol, in accordance with an embodiment of the disclosure. In some embodiments, a system (e.g., similar to one or more of the systems described herein with respect to FIGS. 1A-1C) may perform one or more of the steps of process flow 900. For example, an RPA and ML for dynamic network monitoring and packet validation system (e.g., the system 130 described herein with respect to FIG. 1A-1C) may perform the steps of process flow 900. In some embodiments, an ML model and/or engine (e.g., such as an ML model like that described in FIG. 2) may perform some or all of the steps described in process flow 900.

As shown in block 902, the process flow 900 may include the step of receiving a request to generate a new account. In some embodiments, the request to generate a new account may be transmitted by a user device associated with a new user, a request transmitted via network data packets to create an additional account for a user with at least one existing account, generated by the RPA bot and/or ML engine, and/or the like. A new account may be associated with at least one user, entity, network resource, device and/or the like.

As shown in block 904, the process flow 900 may include the step of receiving, using the RPA bot, account data associated with a user. In some embodiments, the RPA bot may be configured to send and receive account data. The account data associated with a user may comprise a user identity, network resources associated with the user, regulatory and/or governmental data associated with the user, digital tokens associated with the user, financial instruments associated with the user, and/or the like. The account data associated with the user may be transmitted from at least one account data source, according to some embodiments.

As shown in block 906, the process flow 900 may include the step of parsing, using the RPA bot, the account data associated with the user to identify rules data. In some embodiments, the RPA bot may comprise a natural language processing (NLP) application to parse account data associated with the user to identify rules data. According to some embodiments, the NLP application may parse through account data to extract rules data. Rules data may comprise rules that apply to the user, an electronic environment, at least one network device, and/or the like, in accordance with some embodiments of the disclosure provided herein. In some embodiments, the user may be subject to certain rules data and requirements based on their role, network resources, employment history, malicious actor history, and/or the like.

As shown in block 908, the process flow 900 may include the step of executing, using the RPA bot, a rules data verification protocol, wherein the rules data verification protocol comprises validating identification criteria and identifying vulnerabilities associated with the account data associated with the user. In some embodiments, the rules data verification protocol is a requirement promulgated by an external regulatory authority, internal network administrator, user, ML engine, and/or the like for executing any protocol (e.g., network transmission protocol, network threat protocol, rules data verification protocol, account generation protocol, identity registration protocol, and/or the like) within at least one electronic environment. The rules data verification protocol may govern the level of verification requirement for a given request, protocol, and/or the like, according to some embodiments of the disclosure. By way of non-limiting example, and in some embodiments, a request to transfer distributed ledger resources, such as tokens, may require validating the identity of the sender, identity of the recipient, the existence of sender's digital wallet holding the tokens, the existence of the recipient's target digital wallet, the digital wallet containing required token quantities, identifying malicious actor history by sender/or recipient, and/or the like.

Validating identification criteria may comprise validating, confirming, and/or analyzing identity data associated with the sender and/or recipient of a protocol, in some embodiments. By way of a non-limiting example, and in some embodiments, identification criteria may comprise legal name, residence address, shipping address, billing address, date of birth, social security number, passport number, driver's license number, government issued identification number, physical attribute authentication criteria (e.g., iris scans, fingerprints, voice recognition, and/or the like), and/or the like.

In some embodiments, identifying vulnerabilities associated with the account data associated with the user may comprise threat factors associated with the user (e.g., sender, recipient, and/or the like), including without limitation role, network resources, employment history, malicious actor history, background check data, unauthorized access data history, compromised account data, and/or the like.

As shown in block 910, the process flow 900 may include the step of determining, using the RPA bot, an interception threshold based on the rules data verification protocol. The interception threshold may comprise a confidence level associated with requiring an interception to intervene in a protocol (e.g., network transmission protocol, network resource transfer protocol, account generation protocol, identification registration protocol, and/or the like) in some embodiments. The confidence level associated with requiring an interception to intervene in a protocol may comprise a qualitative descriptor, quantitative value, and/or the like associated with triggering an interception, according to some embodiments. The qualitative descriptor may comprise a letter grade (e.g., A to F), a written description (e.g., high, medium, low, and/or the like), and/or the like, according to some embodiments. In some embodiments, the quantitative value may comprise a numerical rating (e.g., whole number, decimals, and/or the like) on a spectrum (e.g., from zero to one hundred), wherein smaller numerical ratings may be associated with a lower interception threshold and higher numerical ratings may be associated with a higher interception threshold, in some embodiments. In some embodiments, the quantitative value may comprise a percentage, wherein a lower percentage is associated with a lower interception threshold and a higher percentage is associated with a higher interception threshold.

An interception may comprise stopping the protocol, shutting down all protocols, generating an alert, shutting down any RPA bot associated with a protocol, locking out at least one user (e.g., sender, recipient, malicious actor, and/or the like), disabling at least one device, shutting down a network, and/or the like, according to some embodiments of the disclosure. By way of non-limiting example, and in some embodiments, the RPA bot may determine the interception threshold based on the rules data verification protocol, determine the interception threshold exceeds a critical level, trigger an interception of the protocol, lock out the sender and/or recipient from accessing any applications associated with the protocol, stop all processing of the protocol, shut down at least one network, remove access of at least one user, and/or generate an alert.

As shown in block 912, the process flow 900 may include the step of executing, using the RPA bot, an account generation protocol and an identification registration protocol, wherein the identification registration protocol comprises transmitting network data packets comprising the account data associated with the user to an external distributed ledger. In some embodiments, the RPA bot may access the account data associated with the user, extract data relevant for the account generation protocol, and execute the account generation protocol, according to some embodiments. In some embodiments, the account generation protocol may comprise generating an account associated with the user, loading account data into at least one application and/or network device, provisioning application access and/or network access to the user, creating authentication credentials, generating an account generation alert, and/or the like.

In some embodiments, the identification registration protocol may comprise aggregating account data relevant for the identification registration protocol, pre-processing the aggregated account data (e.g., data cleansing, encrypting, executing an ETL process, and/or the like), transmitting the aggregated account data via network data packets to an external distributed ledger, and/or the like. After the network data packets are transmitted, the RPA bot may transmit a confirmation message to the external distributed ledger seeking a success determination of the network data packet transmissions and/or receive a confirmation of successful network data packet transmission, according to some embodiments. In some embodiments, the external distributed ledger may reject the network data packets based on at least the identification registration protocol, threats associated with the account data, and/or the like.

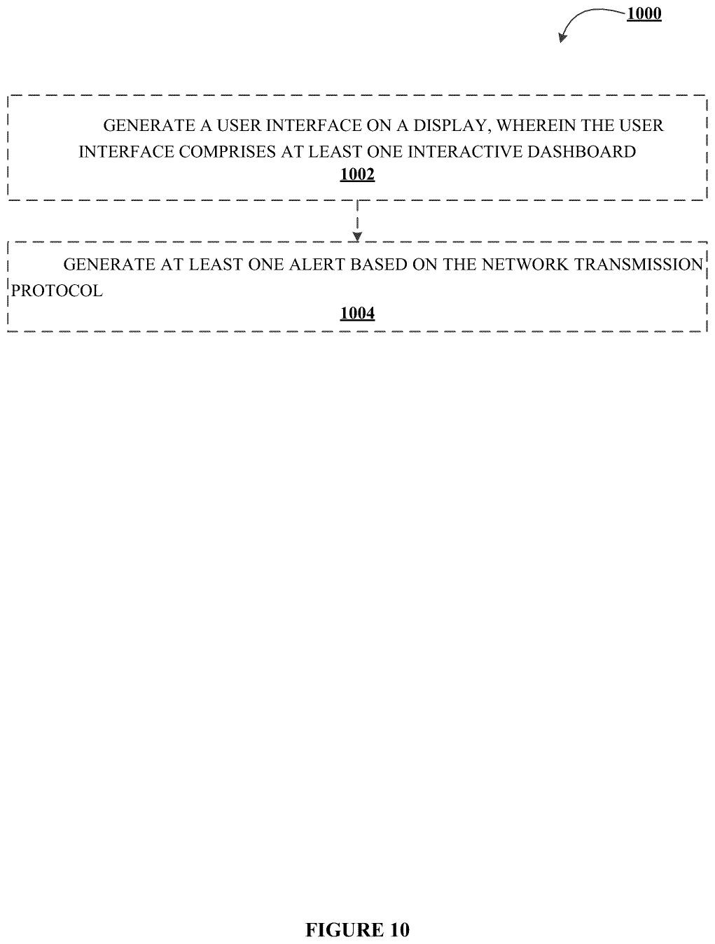

FIG. 10 illustrates a process flow 1000 for generating a user interface and generating least one alert based on the network transmission protocol, in accordance with an embodiment of the disclosure. In some embodiments, a system (e.g., similar to one or more of the systems described herein with respect to FIGS. 1A-1C) may perform one or more of the steps of process flow 1000. For example, an RPA and ML for dynamic network monitoring and packet validation system (e.g., the system 130 described herein with respect to FIG. 1A-1C) may perform the steps of process flow 1000. In some embodiments, an ML model and/or engine (e.g., such as an ML model like that described in FIG. 2) may perform some or all of the steps described in process flow 1000.

As shown in block 1002, the process flow 1000 may include the step of generating a user interface on a display, wherein the user interface comprises at least one interactive dashboard. In some embodiments, the system may generate and display the at least one interactive dashboard for making modifications to the system, viewing analytics, and/or analyzing notifications. In some embodiments, a user may need to authenticate to gain access to the user interface. Authentication may comprise single factor authentication or multifactor authentication, wherein multifactor authentication requires at least two of a one-time password, unique security token generation and authentication, user credentials, physical characteristic authentication, a mobile authenticator application, codes received via messaging service, and/or the like. Once authenticated, a user may navigate the at least one interactive dashboard to view the protocols (e.g., network transmission protocol, network threat protocol, rules data verification protocol, account generation protocol, identity registration protocol, and/or the like), analytics associated with the protocols, historical data associated with the protocols, previously-executed protocols, error logs, intercepted protocols, alerts, notifications, the bot queue, bot criteria associated with the RPA bots, the assignment of the RPA bots to protocols, the at least one historical dataset, the network packet threat data, identification data associated with the RPA bots, and/or the like.

As shown in block 1004, the process flow may include the step of generating at least one alert based on the network transmission protocol. In some embodiments, the network transmission protocol may comprise network packet threat data that requires notification and some responsive action. In such scenarios, the system may generate at least one alert based on at least network packet threat data. The alert may comprise a written description of the network packet threat data, the impacted hardware and software, and/or potential remediation recommendations, according to some embodiments.

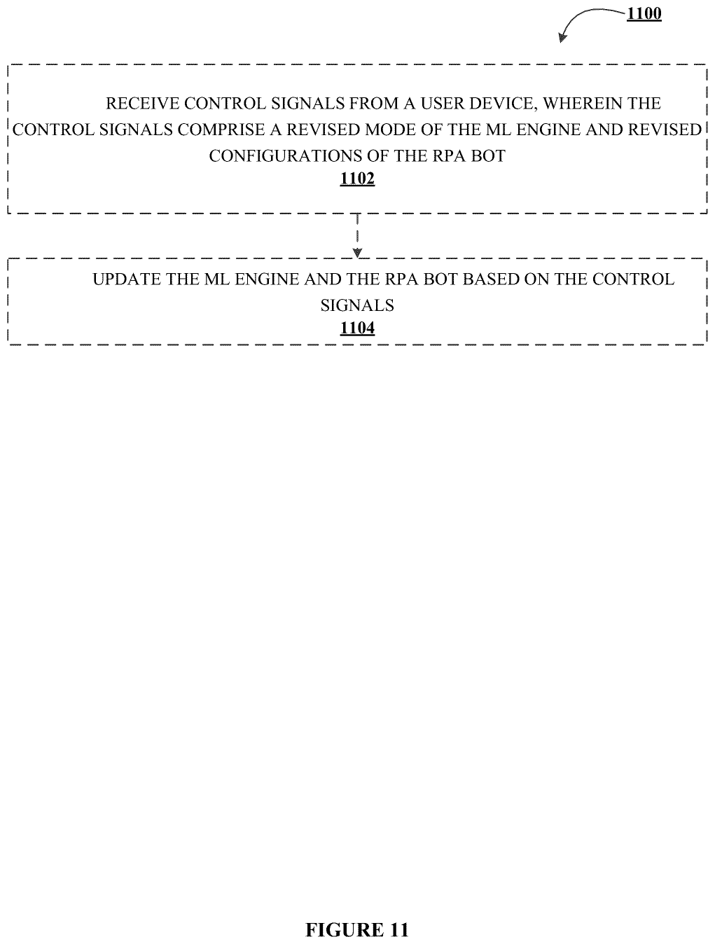

FIG. 11 illustrates a process flow 1100 for modifying the ML engine and the RPA bot, in accordance with an embodiment of the disclosure. In some embodiments, a system (e.g., similar to one or more of the systems described herein with respect to FIGS. 1A-1C) may perform one or more of the steps of process flow 1100. For example, an RPA and ML for dynamic network monitoring and packet validation system (e.g., the system 130 described herein with respect to FIG. 1A-1C) may perform the steps of process flow 1100. In some embodiments, an ML model and/or engine (e.g., such as an ML model like that described in FIG. 2) may perform some or all of the steps described in process flow 1100.

As shown in block 1102, the process flow 1100 may include the step of receiving control signals from a user device, wherein the control signals comprise a revised mode of the ML engine and revised configurations of the RPA bot. In some embodiments, the system may provide for scenario analysis functionality so a user, entity, and/or the like may analyze network threat assessments based on changing conditions. In a non-limiting example, and in some embodiments, the system may provide a network packet threat data simulation application to allow users to simulate scenarios based on different data inputs. In some embodiments, this allows fine-tuning of the ML engine and RPA bots for enhancing performance based on new data. In some embodiments, revising a mode of the ML engine may comprise revising ML models deployed by the ML engine, revising an artificial neural network to enhance ML engine performance, and/or the like.

As shown in block 1104, the process flow 1100 may include the step of updating the ML engine and the RPA bot based on the control signals. In some embodiments, the system may incorporate the changes selected by the user into the ML engine and the RPA bot. The updates to the ML engine and the RPA bot may be incorporated into a test environment version of the ML engine and/or incorporated into a production environment version of the AI engine and the RPA bot, according to some embodiments.

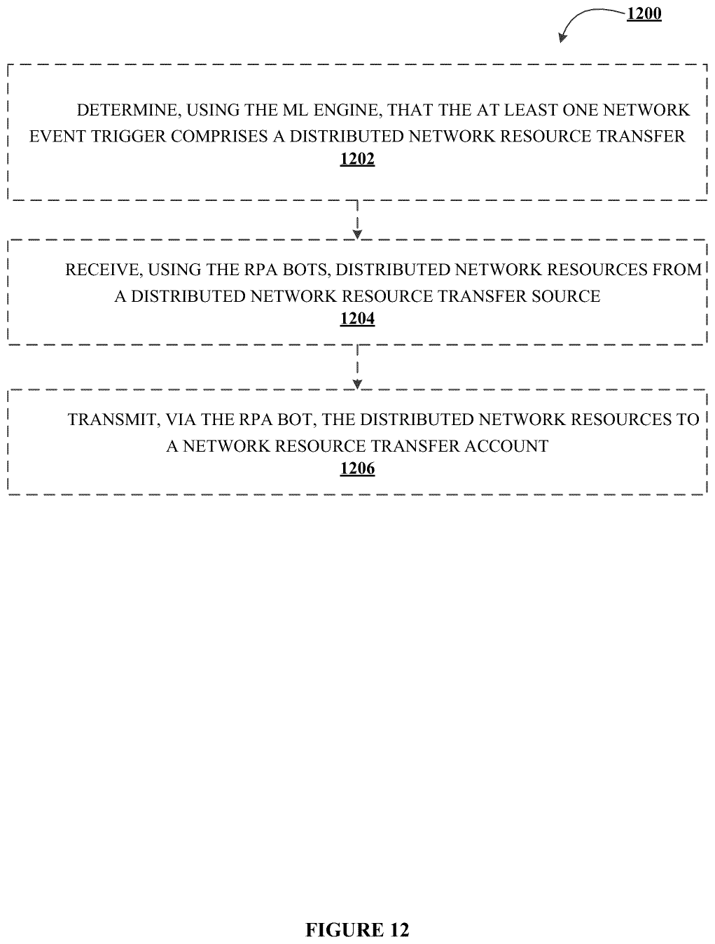

FIG. 12 illustrates a process flow 1200 for transmitting, via the RPA bot, a distributed network resources transmission, in accordance with an embodiment of the disclosure. In some embodiments, a system (e.g., similar to one or more of the systems described herein with respect to FIGS. 1A-1C) may perform one or more of the steps of process flow 1200. For example, an RPA and ML for dynamic network monitoring and packet validation system (e.g., the system 130 described herein with respect to FIG. 1A-1C) may perform the steps of process flow 1200. In some embodiments, an ML model and/or engine (e.g., such as an ML model like that described in FIG. 2) may perform some or all of the steps described in process flow 1200.

As shown in block 1202, the process flow 1200 may include the step of determining, using the ML engine, that the at least one network event trigger comprises a distributed network resource transfer. According to some embodiments of the disclosure, the distributed network resource transfer may comprise a division of distributed network resources, an addition of distributed network resources (e.g., combining distributed network resource A and distributed network resource B), a distributed network resource transfer based on an existing distributed network token, and/or the like. In some embodiments, a distributed network resource transfer may comprise a network transmission protocol comprising cryptocurrency, non-fungible tokens, tokens, virtual tokens, virtual financial instruments, payment instruments, funds, virtual tokens associated with physical objects, and/or the like. In some embodiments, the ML engine may determine a reference address location of a node associated with a sender address on at least one distributed ledger and a reference address location of a node associated with a recipient address on at least one distributed ledger.

As shown in block 1204, the process flow 1200 may include the step of receiving, using the RPA bot, distributed network resources from a distributed network resource transfer source. In some embodiments, the RPA bots may serve as intermediary custodians of the distributed network resources. The RPA bots also may execute a trust algorithm and/or consensus protocol to validate a proposed distributed network resource transfer, according to some embodiments of the disclosure. The trust algorithm and/or consensus protocol may validate the identity of the sender of the distributed network resource transfer and the recipient of the distributed network resource transfer, the quantity of the distributed network resource transfer, the address of the sender and of the recipient, and/or the like, in some embodiments. In some embodiments, the RPA bot may execute a smart contract for the execution and validation of the distributed network resource transfer.

As shown in block 1206, the process flow 1200 may include the step of transmitting, via the RPA bot, the distributed network resources to a network resource transfer account. In some embodiments, transmitting the distributed network resources to a network resource transfer account comprises executing the transfer portion of a smart contract. In some embodiments, the network resource transfer account may be associated with the same entity associated with the system, associated with a different entity than is associated with the system, associated jointly with the same entity associated with the system and at least one other entity, and/or the like. In accordance with some embodiments of the disclosure, the network resource transfer account may comprise a resource account, digital wallet, financial instrument, cryptocurrency wallet, brokerage account, deposit account, bank account, and/or the like. In some embodiments, a notification may be generated and transmitted after validating successful transmission of distributed network resources.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for robotic process automation and machine learning for dynamic network monitoring and packet validation in electronic environments, the system comprising:
a memory device with computer-readable program code stored thereon;
at least one processing device, wherein executing the computer-readable program code is configured to cause the at least one processing device to execute the computer-readable program code to:
extract data from network data packets received from at least one or more data sources;
determine, using a machine learning (ML) engine, at least one network event trigger based on the data;
determine, using the ML engine, bot criteria of a robotic process automation (RPA) bot based on the at least one network event trigger;
assign the RPA bot to execute a network transmission protocol based on at least the bot criteria; and
execute, via the RPA bot, a network transmission protocol.

2. The system of claim 1, wherein executing the computer-readable program code is further configured to cause the at least one processing device to:
determine, using the ML engine, whether the data comprises network rule criteria;
reassign the RPA bot to execute a network threat protocol based on at least the network rule criteria;
execute, using the RPA bot, the network threat protocol, wherein the network threat protocol comprises aggregating network packet threat data;
generate a network threat map based on at least the network rule criteria and the network packet threat data; and
transmit, using the RPA bot, a threat notification, wherein the threat notification comprises the network threat map.

3. The system of claim 1, wherein executing the computer-readable program code is further configured to cause the at least one processing device to:
generate an event trigger forecast ML engine;
update the event trigger forecast ML engine with the data;
generate, using the event trigger forecast ML engine, an event trigger forecasting map;
generate, using the RPA bot, a forecast network transmission protocol based on at least the event trigger forecasting map; and
execute, using the RPA bot, the forecast network transmission protocol.

4. The system of claim 1, wherein executing the computer-readable program code is further configured to cause the at least one processing device to:
determine, using the ML engine, that the at least one network event trigger comprises a network resource transfer request;
assign a second RPA bot to execute a network resource transfer request authentication;
execute, using the second RPA bot, the network resource transfer request authentication, wherein the network resource transfer request authentication comprises at least two of a one-time password, a physical attribute authentication, authentication application, and authentication credentials;
assign the second RPA bot to execute a second network transmission protocol; and
execute, using the second RPA bot, the second network transmission protocol, wherein the network transmission protocol comprises a network resource transfer.

5. The system of claim 4, wherein executing the computer-readable program code is further configured to cause the at least one processing device to:
generate, using the ML engine, a query based on at least the network event trigger;
query at least one internal database based on the query and retrieve query results;
access and retrieve node data from at least one node in a distributed ledger based on at least the query results and the network event trigger;
determine, using the ML engine, a network transmission threshold associated with the node data and the query results; and
validate, using the ML engine, that the network transmission threshold exceeds a network rule threshold.

6. The system of claim 2, wherein executing the computer-readable program code is further configured to cause the at least one processing device to:
receive at least one historical dataset;
train the ML engine based on the at least one historical dataset, wherein the at least one historical dataset comprises at least one of historical network resource transfer data associated with historical network resource transfer criteria, historical validation data associated with validation criteria, historical network rule data associated with historical network rule criteria, or historical network transmission protocols;
receive the network packet threat data;
update the at least one historical dataset with the network packet threat data; and
retrain the ML engine based on the network packet threat data.

7. The system of claim 1, wherein executing the computer-readable program code is further configured to cause the at least one processing device to:
receive a request to generate a new account;
receive, using the RPA bot, account data associated with a user;
parse, using the RPA bot, the account data associated with the user to identify rules data;
execute, using the RPA bot, a rules data verification protocol, wherein the rules data verification protocol comprises validating identification criteria and identifying vulnerabilities associated with the account data associated with the user;
determine, using the RPA bot, an interception threshold based on the rules data verification protocol; and
execute, using the RPA bot, an account generation protocol and an identification registration protocol, wherein the identification registration protocol comprises transmitting network data packets comprising the account data associated with the user to an external distributed ledger.

8. The system of claim 1, wherein executing the computer-readable program code is further configured to cause the at least one processing device to:
generate a user interface on a display, wherein the user interface comprises at least one interactive dashboard; and
generate at least one alert based on the network transmission protocol.

9. The system of claim 1, wherein executing the computer-readable program code is further configured to cause the at least one processing device to:
receive control signals from a user device, wherein the control signals comprise a revised mode of the ML engine and revised configurations of the RPA bot; and
update the ML engine and the RPA bot based on the control signals.

10. The system of claim 1, wherein executing the computer-readable program code is further configured to cause the at least one processing device to:
determine, using the ML engine, that the at least one network event trigger comprises a distributed network resource transfer;
receive, using the RPA bots, distributed network resources from a distributed network resource transfer source; and
transmit, via the RPA bot, the distributed network resources to a network resource transfer account.

11. A computer program product for robotic process automation and machine learning for dynamic network monitoring and packet validation in electronic environments, wherein the computer program product comprises at least one non-transitory computer-readable medium having computer-readable program code portion embodied therein, the computer-readable program code portions which when executed by a processing device are configured to cause a processor to:
extract data from network data packets received from at least one or more data sources;
determine, using a machine learning (ML) engine, at least one network event trigger based on the data;
determine, using the ML engine, bot criteria of a robotic process automation (RPA) bot based on the at least one network event trigger;
assign the RPA bot to execute a network transmission protocol based on at least the bot criteria; and
execute, via a robotic process automation (RPA) bot, a network transmission protocol.

12. The computer program product of claim 11, wherein the processing device is further configured to:
determine, using the ML engine, whether the data comprises network rule criteria;
reassign the RPA bot to execute a network threat protocol based on at least the network rule criteria;
execute, using the RPA bot, the network threat protocol, wherein the network threat protocol comprises aggregating network packet threat data;
generate a network threat map based on at least the network rule criteria and the network packet threat data; and
transmit, using the RPA bot, a threat notification, wherein the threat notification comprises the network threat map.

13. The computer program product of claim 11, wherein the processing device is further configured to:
determine, using the ML engine, that the at least one network event trigger comprises a network resource transfer request;
assign a second RPA bot to execute a network resource transfer request authentication;
execute, using the second RPA bot, the network resource transfer request authentication, wherein the network resource transfer request authentication comprises at least two of a one-time password, a physical attribute authentication, authentication application, and authentication credentials;
assign the second RPA bot to execute a second network transmission protocol; and
execute, using the second RPA bot, the second network transmission protocol, wherein the network transmission protocol comprises a network resource transfer.

14. The computer program product of claim 13, wherein the processing device is further configured to:
generate, using the ML engine, a query based on at least the network event trigger;
query at least one internal database based on the query and retrieve query results;
access and retrieve node data from at least one node in a distributed ledger based on at least the query results and the network event trigger;
determine, using the ML engine, a network transmission threshold associated with the node data and the query results; and
validate, using the ML engine, that the network transmission threshold exceeds a network rule threshold.

15. The computer program product of claim 11, wherein the processing device is further configured to:
determine, using the ML engine, that the at least one network event trigger comprises a distributed network resource transfer;
receive, using the RPA bots, distributed network resources from a distributed network resource transfer source; and
transmit, via the RPA bot, the distributed network resources to a network resource transfer account.

16. A computer-implemented method for robotic process automation and machine learning for dynamic network monitoring and packet validation in electronic environments:
extracting data from network data packets received from at least one or more data sources;
determining, using a machine learning (ML) engine, at least one network event trigger based on the data;
determine, using the ML engine, bot criteria of a robotic process automation (RPA) bot based on the at least one network event trigger;
assign the RPA bot to execute a network transmission protocol based on at least the bot criteria; and
executing, via a robotic process automation (RPA) bot, a network transmission protocol.

17. The computer-implemented method of claim 16, wherein the computer-implemented method is further configured for:
determining, using the ML engine, whether the data comprises network rule criteria;
reassigning the RPA bot to execute a network threat protocol based on at least the network rule criteria;
executing, using the RPA bot, the network threat protocol, wherein the network threat protocol comprises aggregating network packet threat data;
generating a network threat map based on at least the network rule criteria and the network packet threat data; and
transmitting, using the RPA bot, a threat notification, wherein the threat notification comprises the network threat map.

18. The computer-implemented method of claim 16, wherein the computer-implemented method is further configured for:
determining, using the ML engine, that the at least one network event trigger comprises a network resource transfer request;
assigning a second RPA bot to execute a network resource transfer request authentication;
executing, using the second RPA bot, the network resource transfer request authentication, wherein the network resource transfer request authentication comprises at least two of a one-time password, a physical attribute authentication, authentication application, and authentication credentials;
assigning the second RPA bot to execute a second network transmission protocol; and
executing, using the second RPA bot, the second network transmission protocol, wherein the network transmission protocol comprises a network resource transfer.

19. The computer-implemented method of claim 18, wherein the computer-implemented method is further configured for:
generating, using the ML engine, a query based on at least the network event trigger;
querying at least one internal database based on the query and retrieve query results;
accessing and retrieving node data from at least one node in a distributed ledger based on at least the query results and the network event trigger;
determining, using the ML engine, a network transmission threshold associated with the node data and the query results; and
validating, using the ML engine, that the network transmission threshold exceeds a network rule threshold.

20. The computer-implemented method of claim 16, wherein the computer-implemented method is further configured for:
determining, using the ML engine, that the at least one network event trigger comprises a distributed network resource transfer;
receiving, using the RPA bots, distributed network resources from a distributed network resource transfer source; and
transmitting, via the RPA bot, the distributed network resources to a network resource transfer account.
